(19) United States
(12) Patent Application Publication
(10) Pub. No.: US 2024/0314003 A1
(43) Pub. Date: Sep. 19, 2024

(54) Transmitter, Receiver and Method for Transmit and Receive Filtering in a Communication System

(71) Applicant: Nokia Technologies Oy, Espoo (FI)

(72) Inventors: Faycal AIT AOUDIA, Saint-Cloud (FR); Jakob HOYDIS, Paris (FR)

(21) Appl. No.: 18/573,567

(22) PCT Filed: Jun. 28, 2021
(86) PCT No.: PCT/EP2021/067677

§ 371 Date: Dec. 22, 2023

(51) Int. Cl. H04L 25/03

(52) U.S. Cl. CPC H04L 25/03834; H04L 25/03165

(57) ABSTRACT

In a communication system, a transmitter includes a transmit filter for pulse shaping to produce a transmit signal subject to a signal constraint for transmission over a channel to a receiver, and the receiver includes a receive filter to process a received signal. The transmit and receive filters are implemented through a filtering function with trainable parameters, the parameters obtained by joint optimization of the transmit and receive filters to maximize the transmission rate for the channel model and the signal constraint. The learning method for obtaining the parameters includes: simulating the channel response depending on the transmit and receive filters, simulating a channel noise correlation depending on the receive filter, computing channel outputs for random samples by applying the simulated channel response and a random noise correlated to reflect the simulated channel noise correlation, learning the parameters by minimizing a loss function subject to at least one signal constraint.

### TECHNICAL FIELD

Various example embodiments relate generally to a communication system comprising a transmission channel, a transmitter and a receiver, where the transmitter comprises a transmit filter to perform pulse shaping and produce a transmit signal for transmission over the transmission channel to the receiver, and the receiver comprises a receive filter to process a signal received from the transmitter through the transmission channel.

### BACKGROUND

Communication systems commonly use transmit and receive filters to shape the signal to be transmitted over a communication channel between a transmitter and a receiver. Transmit and receive filters are typically designed using conventional signal processing techniques. A typical example of implementation for the transmit and receive filters is to use root-raised-cosine (RRC) filter. The design of the transmit and receive filters is guided by the many constraints that the waveform generated by the transmitter must fulfill, including constraints on out-of-band emissions and peak power. Moreover, the receive filter impacts the correlation of the baseband noise samples. The transmit and receive filters are typically chosen such that, at the receiver, the reconstructed symbols do not experience intersymbol interference (ISI) due to the filtering. Such filters are said to satisfy the Nyquist ISI criterion.

It is foreseen that sub-terahertz frequency bands will be extensively used in future wireless networks. At such high frequencies, the lower efficiencies of power amplifiers, more stringent regulations on the power spectral density (PSD), and higher phase noise, among others, make the design of the transmit and receive filters even more challenging.

In the context of sub-terahertz communication, designing filters that meet the strong requirements on peak power and out-of-band emissions, while achieving the highest possible throughput, is still an open issue.

### SUMMARY

The scope of protection is set out by the independent claims. The embodiments, examples and features, if any, described in this specification that do not fall under the scope of the protection are to be interpreted as examples useful for understanding the various embodiments or examples that fall under the scope of protection.

According to a first aspect, a transmitter is disclosed for use in a communication system comprising a transmission channel with a channel model, the transmitter comprising a transmit filter to perform pulse shaping to produce a transmit signal subject to at least one signal constraint for transmission over the transmission channel to a receiver comprising a receive filter, the transmit filter being implemented through a filtering function with trainable parameters, wherein the trainable parameters of the filtering function are obtained by joint optimization of the transmit filter and the receive filter to maximize the transmission rate for the channel model and the signal constraint.

According to a second aspect, a receiver is disclosed for use in a communication system comprising a transmission channel with a channel model and a transmitter, the transmitter comprising a transmit filter to perform pulse shaping to produce a transmit signal subject to at least one signal constraint, the receiver comprising a receive filter for processing a signal received through the transmission channel from the transmitter, the receive filter being implemented through a filtering function with trainable parameters, wherein the trainable parameters of the filtering function are obtained by joint optimization of the transmit filter and the receive filter to maximize the transmission rate for the channel model and the signal constraint.

In a disclosed embodiment, the trainable parameters of the filtering function are obtained by joint optimization of the transmit filter, the receive filter and a neural network implementing at least a detection function of the receiver.

In a disclosed embodiment of the transmitter, the filtering function is implemented by taking a single period of a Fourier series with Fourier coefficients, where the trainable parameters of the filtering function are the Fourier coefficients.

In a disclosed embodiment of the receiver, the filtering function is implemented by taking a single period of a Fourier series with Fourier coefficients, where the trainable parameters of the filtering function are the Fourier coefficients.

In a disclosed embodiment, the filtering function is implemented as an output layer of a neural network comprising at least one other layer to process transmission-related information, for example information about the channel state (e.g. the Signal to Noise ratio).

According to another aspect, a learning method is disclosed for learning parameters for a transmit filtering function with trainable parameters and a receive filtering function with trainable parameters to be used respectively in a transmitter and a receiver of a communication system comprising a transmission channel, the method comprising:
simulating a channel response taking into account the transmit and receive filters,
simulating a channel noise correlation taking into account the receive filter,
computing channel outputs for random samples by applying the simulated channel response and a random noise correlated to reflect the simulated channel noise correlation,
learning the trainable parameters by minimizing a loss function subject to at least one signal constraint.

In a disclosed embodiment of the learning method, the signal constraint includes keeping an adjacent channel leakage ratio (ACLR) lower or equal to a predefined value.

In a disclosed embodiment of the learning method, the loss function is minimized by performing a gradient descent on an augmented Lagrangian combining the loss function with the signal constraint.

In a disclosed embodiment of the learning method, the loss function is an estimation of a total binary cross-entropy obtained through Monte Carlo sampling.

According to another aspect, the use of parameters obtained from the learning method is disclosed for filtering a signal by a transmit filter in a transmitter of a communication system.

According to another aspect, the use of parameters obtained from the learning method is disclosed for filtering a signal by a receive filter in a transmitter of a communication system.

According to another aspect, a transmission method is disclosed for use in a transmitter in a communication system comprising a transmission channel with a channel model, the method comprising performing pulse shaping by a transmit filter to produce a transmit signal subject to at least one signal constraint for transmission over the transmission channel to a receiver comprising a receive filter, wherein the transmit filter is implemented with a filtering function with trainable parameters, and the trainable parameters of the filtering function are obtained by joint optimization of the transmit filter and the receive filter to maximize the transmission rate for the channel model and the signal constraint.

According to another aspect, a reception method is disclosed for use in a receiver in a communication system comprising a transmission channel with a channel model and a transmitter, the transmitter comprising a transmit filter to perform pulse shaping to produce a transmit signal subject to at least one signal constraint, the method comprising processing, by a receive filter, a signal received through the transmission channel from the transmitter, wherein the receive filter is implemented through a filtering function with trainable parameters, and the trainable parameters of the receive filtering function are obtained by joint optimization of the transmit filter and the receive filter to maximize the transmission rate for the channel model and the signal constraint.

According to another aspect, a transmission method and a reception method are disclosed wherein the filtering function is implemented by taking a single period of a Fourier series with Fourier coefficients, where the trainable parameters of the filtering function are the Fourier coefficients.

According to another aspect a computer program product is disclosed comprising a set of instructions which, when executed on an apparatus cause the apparatus to carry out the learning method as disclosed herein.

According to another aspect a computer program product is disclosed comprising a set of instructions which, when executed on a transmitter or a receiver, is configured to cause the transmitter or respectively the receiver to carry out a transmission method or respectively a reception method as disclosed herein.

According to an embodiment the disclosed computer program product is embodied as a computer readable medium or directly loadable into a computer.

For on-line learning of the parameters the learning method may be implemented in the transmitter and in the receiver. In this embodiment the transmitter and the receiver comprise means for performing one or more or all steps of a learning method as disclosed herein. The means may include circuitry configured to perform one or more or all steps of the learning method as disclosed herein. The circuitry may be dedicated circuitry. The means may also include at least one processor and at least one memory including computer program code, wherein the at least one memory and the computer program code are configured to, with the at least one processor, cause the transmitter and respectively the receiver to perform one or more or all steps of the learning method as disclosed herein.

Alternatively the learning method can be implemented in another apparatus in the network and the learned parameters may be transmitted to the transmitter and the receiver over a network connection.

Generally, the transmitter and the receiver comprise means for performing one or more or all steps of a transmission or a reception method as disclosed herein. The means may include circuitry configured to perform one or more or all steps of the transmission or the reception method as disclosed herein. The circuitry may be dedicated circuitry. The means may also include at least one processor and at least one memory including computer program code, wherein the at least one memory and the computer program code are configured to, with the at least one processor, cause the transmitter or respectively the receiver to perform one or more or all steps of the transmission method or respectively the reception method as disclosed herein.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 is a schematic representation of a first embodiment of a communication system comprising a transmitter a receiver and a communication channel.

FIG. 2. is a schematic representation of a second embodiment of a communication system comprising a transmitter a receiver and a communication channel.

FIG. 3A and FIG. 3B illustrate an implementation of a transmit and receive filter respectively in a first exemplary embodiment.

FIG. 4A and FIG. 4B illustrate an implementation of a transmit and receive filter respectively in a second exemplary embodiment.

FIG. 5 illustrate an exemplary embodiment of a learning method to obtained trainable parameters for implementing a transmit or a receive filter.

FIG. 6 illustrate an exemplary embodiment of a neural network-based detector for use in a receiver.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing example embodiments. The example embodiments may, however, be embodied in many alternate forms and should not be construed as limited to only the embodiments set forth herein. Accordingly, while example embodiments are capable of various modifications and alternative forms, the embodiments are shown by way of example in the drawings and will be described herein in detail. It should be understood, however, that there is no intent to limit example embodiments to the particular forms disclosed.

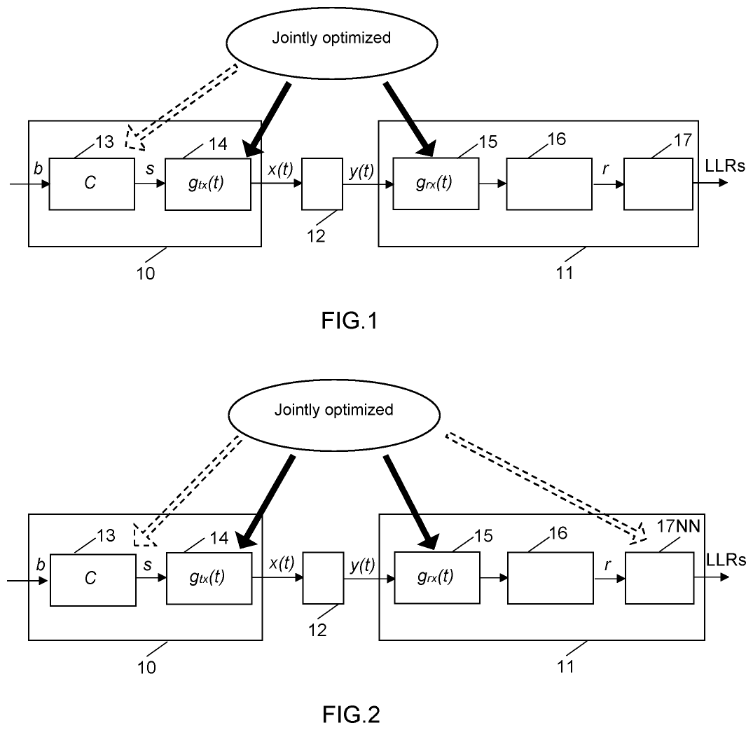

FIG. 1 illustrates a first exemplary embodiment of a communication system as disclosed herein. The communication system of FIG. 1 comprises a transmitter 10, a receiver 11 and a transmission channel 12 characterized by a channel model. As depicted in FIG. 1 the transmitter 10 comprises a modulator 13 to modulate a vector of coded bits b according to a constellation C and generate a vector of symbols s. The vector s is then filtered using a transmit filter 14 to generate a time continuous signal x(t) to be transmitted through the communication channel 12. At the receiver 11 a received signal y(t) is filtered using a receive filter 15. Then it is sampled by sampler 16 to generate a vector of received symbols r. The received symbols r are then processed by a detector 17 which computes log-likelihood ratios (LLRs) of the transmitted coded bits. The transmitter 10 and the receiver 11 operate on block of consecutive samples. In the following of the description, the number of samples in a block is denoted N.

As depicted in FIG. 1, the transmit and receive filters are implemented through a filtering function with trainable parameters, denoted gₜₓ(t) and gᵣₓ(t) respectively. And the trainable parameters of the filtering functions gₜₓ(t) and gᵣₓ(t) are obtained by joint optimization of the transmit filter 14 and the receive filter 15 to maximize the transmission rate for the channel model and at least one predefined signal constraint. In other words, the transmit filter 14 and the receive filter 15 are trained in an end-to-end manner for a given channel model and constraints on the waveform in order to maximize the throughout.

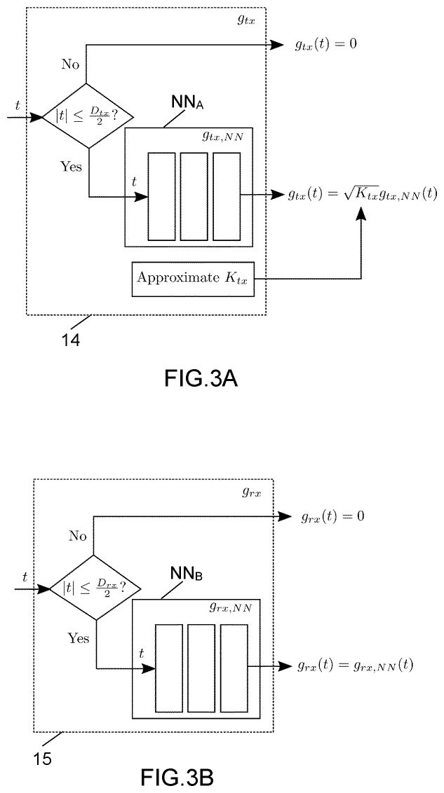

FIG. 2 illustrates a second exemplary embodiment of a communication system as disclosed herein. As depicted in FIG. 2, the detector is a neural network-based detector 17NN. In this embodiment, the trainable parameters of the filtering functions gₜₓ(t) and gᵣₓ(t) are obtained by joint optimization of the transmit filter 14, the receive filter 15 and a neural network based detector 17NN. In this second embodiment, the transmit filter 14, the receive filter 15 and a neural network-based detector 17NN are trained in an end-to-end manner for the channel model and constraints on the waveform in order to maximize the throughout.

For example the signal constraint can be set on the Adjacent Channel Leakage Ratio (ACLR) or the Peak-to-Average Power Ratio (PAPR).

As illustrated in FIG. 1 and FIG. 2 through doted arrows, as an option, the geometry of constellation [symbol] and the bit labelling used to modulate the bits b into baseband symbols s can also be jointly optimized with the transmit filter 14, the receiver filter 15 and, in the exemplary embodiment of FIG. 2, the neural network-based detector 17NN.

In a specific embodiment, the filtering functions are implemented as an output layer of a neural network having at least one other layer to process information about the channel state, for example an estimate of the Signal-to-Noise Ratio (SNR).

With reference to FIG. 1 and FIG. 2, at transmitter 10, the vector of coded bits b∈{0,1}^{NK}, is modulated onto the vector of symbols s∈ [symbol] ^{N} according to constellation [symbol] with modulation order 2^{K}, e.g., a quadrature amplitude modulation (QAM). N is the block size and K the number of bits per symbol. The vector s is then filtered using the transmit filtering function gₜₓ(t), to generate the time-continuous signal

$$x ( t ) = {\sum }_{n = 0}^{N - 1} {s}_{n} {g}_{tx} ( t - nT )$$

where T is the symbol time. The signal x(t) is then transmitted over the channel 12.

In the embodiment described in the following of the description, channel 12 is a multipath channel which is typical in wireless communication systems. However the disclosure is not limited to multipath channels. It applies to other types of channels with other channel models, for example optical channels, underwater channels, molecular channels, VLC channels, etc. . . . Other channel models would lead to other mathematical expressions for the channel response and the channel noise correlation but the principles of the present disclosure would apply in the same manner.

At the receiver 11, the received baseband signal y(t) is filtered using the receive filtering function gᵣₓ(t), and then sampled at rate T to generate the vector of received complex symbols r∈ [symbol] ^{N}:

$${r}_{m} = \int y ( τ ) {g}_{rx} ( mT - τ ) d τ = {\sum }_{l} {s}_{m - l} {h}_{l} + {w}_{m} \qquad ( A )$$

where wₘ is the additive noise, and

$${h}_{l} = {\sum }_{i = 1}^{P} {a}_{i} α ( lT - {δ}_{i} )$$

where the sum is over the P paths of the multipath channel 12, each path i having aᵢ as amplitude response and δᵢ as delay. As channel 12 is a time varying channel, aᵢ and δᵢ also depend on m. The function α(t) is the filter response. It is the convolution of the transmit and receive filters 10 and 11 and can be expressed as:

$$α ( t ) = {\int }_{- \frac{{D}_{tx}}{2}}^{\frac{{D}_{tx}}{2}} {g}_{tx} ( τ ) {g}_{rx} ( t - τ ) d τ . \qquad ( B )$$

Unlike traditional filters, the disclosed transmit and receive filters don't satisfy the Nyquist criterium. Therefore the reconstructed symbols experience intersymbol interference. The correlation of the additive noise wₘ depends on the receive filter 15 and can be expressed as:

$$𝔼 [ {w}_{m} {w}_{k}^{*} ] = {N}_{0} {\int }_{- \frac{{D}_{rx}}{2}}^{\frac{{D}_{rx}}{2}} {g}_{rx} ( τ ) {g}_{rx} ( τ - ( m - k ) T ) d τ \qquad ( C )$$

where N₀ is the channel additive white noise power spectral density.

The vector of received symbols r is then processed by the detector 17 or 17NN which computes log-likelihood ratios (LLRs) of the transmitted coded bits. The LLRs can then be further processed by a channel decoder, for example a belief propagation algorithm, to reconstruct the transmitted information bits.

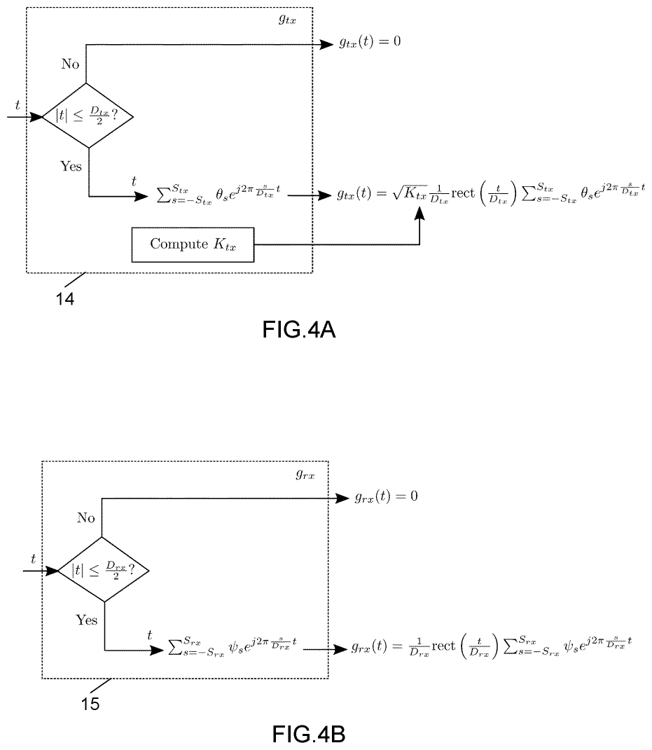

In a first embodiment the transmit and receive filter are implemented by using neural networks. Such a neural network-based implementation is described below in relation to FIG. 3A for transmitter 10 and FIG. 3B for receiver 11.

With reference to FIG. 3A, the transmit filter 14 is implemented by a neural network NN_{A} with trainable weights, which takes as input the time t∈ [symbol] , and outputs g_{tx,NN}(t)∈ [symbol] . Similarly, with reference to FIG. 3B, the receive filter 15 is implemented by a neural network NN_{B} with trainable weights which takes as input the time t∈ [symbol] , and outputs g_{rx,NN}(t)∈ [symbol] .

Practical filters must be time-limited. This can be enforced by defining the transmit filter as

$${g}_{tx} ( t ) = \{ \begin{matrix}\sqrt{{K}_{tx}} {g}_{tx , NN} ( t ) , if \vert t \vert < \frac{{D}_{tx}}{2} \\ 0 , otherwise\end{matrix}$$

where Dₜₓ is the duration of the transmit filter, and Kₜₓ a normalization constant. Similarly,

$${g}_{rx} ( t ) = \{ \begin{matrix}{g}_{rx , NN} ( t ) , if \vert t \vert < \frac{{D}_{rx}}{2} \\ 0 , otherwise\end{matrix}$$

where Dᵣₓ is the duration of the receive filter.

At the transmitter side, the normalization constant Kₜₓ is used to ensure that an energy constraint is satisfied as expressed below:

$${\int }_{- ∞}^{∞} {\vert {g}_{tx} ( t ) \vert}^{2} dt = {K}_{tx} {\int }_{- \frac{{D}_{tx}}{2}}^{\frac{{D}_{tx}}{2}} {\vert {g}_{tx , NN} ( t ) \vert}^{2} dt = 1$$

This can be achieved by setting the normalization constant Kₜₓ to

$${K}_{tx} = \frac{1}{{\int }_{- \frac{{D}_{tx}}{2}}^{\frac{{D}_{tx}}{2}} {\vert {g}_{tx , NN} ( t ) \vert}^{2} dt} \qquad ( D )$$

A monte Carlo estimation of the integral in the denominator of (D) can be used to obtain an estimation of the normalization constant Kₜₓ:

$${K}_{tx} \approx \frac{1}{{D}_{tx} \frac{1}{{B}_{1}} {\sum }_{i = 1}^{{B}_{1}} {\vert {g}_{tx , NN} ( {t}^{[ i ]} ) \vert}^{2}}$$

where B₁ is the number of samples used to compute the approximation of the integral, and t^{[i]} are time samples randomly and uniformly chosen from the interval

$$( - \frac{{D}_{t x}}{2} , \frac{{D}_{t x}}{2} ) .$$

B₁ controls a tradeoff between accuracy of the approximation and computational complexity.

To enable training of the end-to-end system, the channel transfer function (A) must be simulated which requires computation of the filter response (B).

In an embodiment, this is achieved by approximating the filter response α(t) by Monte Carlo sampling:

$$α ( t ) \approx {D}_{tx} \frac{1}{{B}_{2}} {\sum }_{i = 1}^{{B}_{2}} {g}_{tx} ( {τ}^{[ i ]} ) {g}_{rx} ( t - {τ}^{[ i ]} )$$

where B₂ is the number of samples used to compute the approximation, and τ^{[i]} are time samples randomly chosen from

$$( - \frac{{D}_{t x}}{2} , \frac{{D}_{t x}}{2} ) .$$

B₂ controls a tradeoff between accuracy of the approximation and computational complexity.

Training of the end-to-end system also requires simulating the additive noise samples accurately, which requires the computation of the noise correlation (C). In an embodiment, this is also achieved through a Monte Carlo approximation:

$$𝔼 [ {w}_{m} {w}_{k}^{*} ] \approx {N}_{0} {D}_{rx} \frac{1}{{B}_{3}} {\sum }_{i = 1}^{{B}_{3}} {g}_{rx} ( {τ}^{[ i ]} ) {g}_{rx} ( {τ}^{[ i ]} - ( m - k ) T )$$

where B₃ is the number of samples used to compute the approximation, and τ^{[i]} are time samples randomly chosen from

$$( - \frac{{D}_{r x}}{2} , \frac{{D}_{r x}}{2} )$$

B₃ controls a tradeoff between accuracy and complexity.

Implementing the transmit and receive filters by neural networks as described in the first embodiment is computationally demanding at training, as the filter response (B), noise correlation (C), and normalization constant of the transmit filter (D) need to be approximated with Monte Carlo sampling.

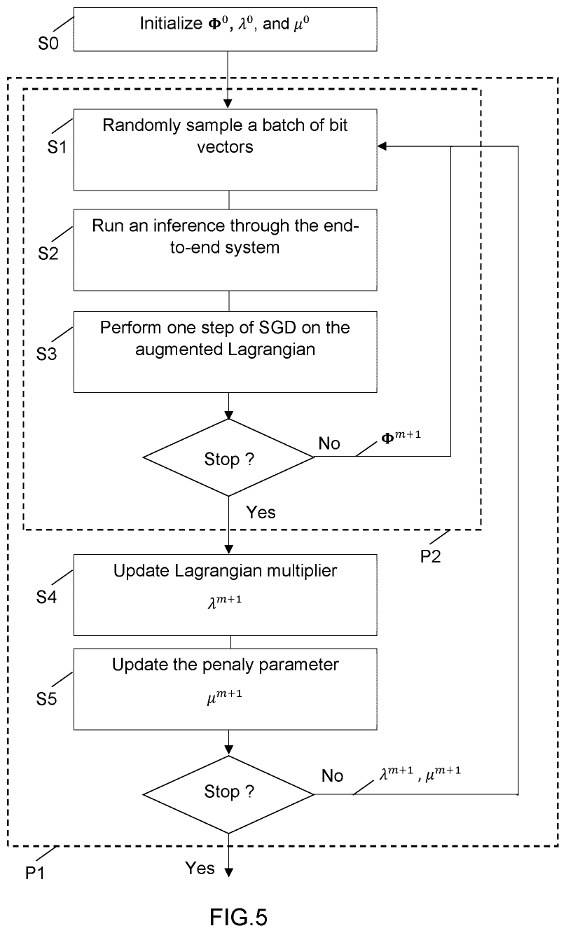

A second embodiment which is less computationally demanding will now be described with reference to FIG. 4A and FIG. 4B. In this second embodiment, the filtering functions are implemented by taking a single period of a Fourier series with Fourier coefficients, where the trainable parameters of the filtering function are the Fourier coefficients.

In the frequency domain, the transmit and receive filters are defined as follows:

$$\begin{matrix}{\hat{g}}_{tx} ( f ) = \sqrt{{K}_{tx}} {\sum }_{s = - {S}_{t x}}^{{S}_{t x}} {θ}_{s} sin c ( {D}_{tx} f - s ) \\ {\hat{g}}_{rx} ( f ) = {\sum }_{s = - {S}_{r x}}^{{S}_{r x}} {ψ}_{s} sin c ( {D}_{rx} f - s )\end{matrix}$$

where

$$sin c ( x ) := \frac{sin ( π x )}{π x} ,$$

and Sₜₓ and Sᵣₓ control the number of trainable parameters of the transmit and receive filters, respectively. θ=[θ_{-S}_{ₜₓ}, . . . ,θ_{S}_{ₜₓ}]^{T}∈ [symbol] ^{2S}^{ₜₓ}⁺¹ is the vector of trainable parameters of the transmit filter, and Ψ=[Ψ_{-S}_{ᵣₓ}, . . . ,Ψ_{S}_{ᵣₓ}]^{T}∈ [symbol] ^{2S}^{ᵣₓ}⁺¹ the vector of trainable parameters of the receive filter.

Transformation into the time domain leads to the following expressions of the transmit and receive filters:

$$\begin{matrix}{g}_{tx} ( t ) = \sqrt{{K}_{tx}} \frac{1}{{D}_{tx}} rect ( \frac{t}{{D}_{tx}} ) {\sum }_{s = - {S}_{t x}}^{{S}_{t x}} {θ}_{s} {e}^{j 2 π \frac{s}{{D}_{t x}} t} \\ {g}_{rx} ( t ) = \frac{1}{{D}_{rx}} rect ( \frac{t}{{D}_{rx}} ) {\sum }_{s = - {S}_{r x}}^{{S}_{rx}} {ψ}_{s} {e}^{j 2 π \frac{s}{{D}_{rx}} t}\end{matrix}$$

where

$$rect ( t ) = \{ \begin{matrix}1 if \vert t \vert \leq \frac{1}{2} \\ 0 , otherwise\end{matrix} .$$

As S tends toward infinity, the set of functions {sinc(Df−s)}_{s=-S . . . S} forms a basis in the frequency domain of the set of all functions time-limited to D. The parameters Sₜₓ and Sᵣₓ control a tradeoff between complexity and degrees of freedom of the trainable filters.

The practical benefit of using such functions to implement the transmit and receive filters is that the filter response (B), noise correlation (C), and normalization constant (D) can be computed exactly (and not approximately as in the first embodiment) and with low complexity (as no Monte Carlo sampling is required). Indeed, a direct calculation shows that

$$\begin{matrix}{K}_{tx} = \frac{{D}_{tx}}{{θ}^{H} θ} \\ α ( t ) = \frac{\sqrt{{K}_{tx}}}{{D}_{tx}} {θ}^{T} A ( t ) ψ\end{matrix}$$

and

$$𝔼 [ {w}_{m} {w}_{k}^{*} ] = \frac{1}{{D}_{rx}} {ψ}^{T} B ( t ) ψ$$

where A(t) is the (2Sₜₓ+1)×(2Sᵣₓ+1) matrix which coefficients are given by

$${A ( t )}_{{s}_{1} , {s}_{2}} = \{ \begin{matrix}{e}^{j 2 π \frac{{s}_{1}}{{D}_{t x}}} Δ ( t ) \\ {e}^{j 2 π \frac{{s}_{1}}{{D}_{t x}}} \frac{sin ( π ( {s}_{1} - {s}_{2} ) Δ ( t ) ) cos ( π ( {s}_{1} - {s}_{2} ) ( t ) ) + j sin ( π ( {s}_{1} - {s}_{2} ) Δ ( t ) ) sin ( π ( {s}_{1} - {s}_{2} ) ( t ) )}{π ( {s}_{1} - {s}_{2} )}\end{matrix}$$

where −Sₜₓ≤s₁≤Sₜₓ, −Sᵣₓ≤s₂≤Sᵣₓ, Δ(t)=Iₘₓ(t)−Iₘₙ(t) and S(t)=Iₘₓ(t)+Iₘₙ(t), with

$${I}_{m x} ( t ) = min ( \frac{1}{2} ; \frac{t}{{D}_{t x}} + \frac{1}{2} )$$

and

$${I}_{m n} ( t ) = max ( - \frac{1}{2} ; \frac{t}{{D}_{t x}} - \frac{1}{2} ) .$$

Similarly, B(t) is the (2Sᵣₓ+1)×(2Sᵣₓ+1) matrix which coefficients are given by

$${B ( t )}_{{s}_{1} , {s}_{2}} = \{ \begin{matrix}{e}^{j 2 π \frac{{s}_{1}}{{D}_{r x}}} {Δ}^{′} ( t ) \\ {e}^{j 2 π \frac{{s}_{1}}{{D}_{r x}}} \frac{sin ( π ( {s}_{1} + {s}_{2} ) {Δ}^{′} ( t ) ) cos ( π ( {s}_{1} + {s}_{2} ) {′}^{} ( t ) ) + j sin ( π ( {s}_{1} + {s}_{2} ) {Δ}^{′} ( t ) ) sin ( π ( {s}_{1} + {s}_{2} ) {′}^{} ( t ) )}{π ( {s}_{1} - {s}_{2} )}\end{matrix}$$

where −Sᵣₓ≤s₁, s₂≤Sᵣₓ, Δ′(t)=I′ₘₓ(t)−I′ₘₙ(t) and S′(t)=I′ₘₓ(t)+I′ₘₙ(t), with

$${I}_{mx}^{′} ( t ) = min ( \frac{1}{2} ; \frac{- t}{{D}_{rx}} + \frac{1}{2} )$$

and

$${I}_{mn}^{′} ( t ) = max ( - \frac{1}{2} ; \frac{- t}{{D}_{rx}} - \frac{1}{2} ) .$$

The trainable parameters of the filtering functions gₜₓ(t) and gᵣₓ(t) are obtained by joint optimization of the transmit filter 14, the receive filter 15, optionally the neural network based-detector 17NN and the modulator 13 as mentioned previously.

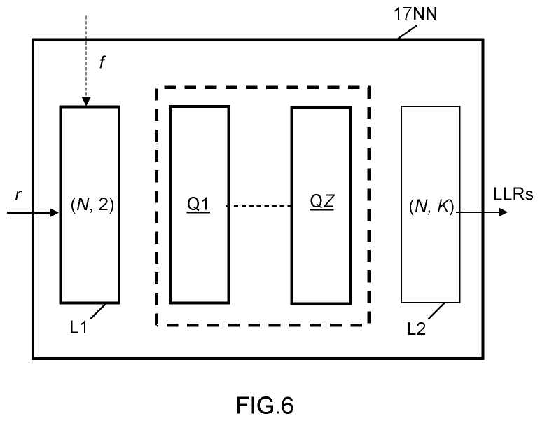

An exemplary learning method for learning the trainable parameters will now be described with reference to FIG. 5.

The learning method comprises simulating the channel response, simulating the channel noise correlation, computing channel outputs for random samples by applying the simulated channel response and a random noise correlated to reflect the simulated channel noise correlation, and learning the trainable parameters by minimizing a loss function [symbol] (Φ) subject to at least one signal constraint, for example a constraint set on the ACLR.

In the following, the set of trainable parameters of the end-to-end system is denoted by Φ. It consists of the weights of the transmit filter 14, receive filter 15, optionally the neural network-based detector 17NN and possibly other trainable parameters at the transmitter (for example the parameters of the modulator 13).

In the example described below the objective of minimizing the out of band emission is achieved by maximizing the achievable information rate under the constraint of keeping the adjacent channel leakage ratio (ACLR) equal to a predefined value ϵ>0. This problem can be formulated as a constrained optimization problem:

$${Min}_{Φ} 𝒥 ( Φ ) \qquad ( E )$$

$$subject to$$

$$ACLR ( Φ ) = ϵ$$

where the loss function [symbol] (Φ) is the total binary cross-entropy defined by

$$𝒥 ( Φ ) := \frac{1}{NK} {\sum }_{n = 1}^{N} {\sum }_{k = 1}^{K} {𝔼}_{{b}_{n , k} , r} [ - log \hat{P} ( {b}_{n , k} \vert r ) ]$$

and ϵ is the ACLR constraint.

This loss function is estimated through Monte Carlo sampling in practice, using batches of B₄ samples:

$$𝒥 ( Φ ) \approx - \frac{1}{{NKB}_{4}} {\sum }_{b = 1}^{{B}_{4}} {\sum }_{n = 1}^{N} {\sum }_{k = 1}^{K} {b}_{n , k}^{[ b ]} log \hat{P} ( {b}_{n , k}^{[ b ]} = 1 \vert {r}^{[ b ]} ) + ( 1 - {b}_{n , k}^{[ b ]} ) log \hat{P} ( {b}_{n , k}^{[ b ]} = 0 \vert {r}^{[ b ]} ) ,$$

where the superscript [b] refers to the b^{th} batch example.

The ACLR is defined as

$$ACLR ( Φ ) := \frac{Out of band energy}{In band energy} = \frac{Total energy - In band energy}{In band energy} = \frac{1}{In band energy} - 1$$

The Total energy is equal to 1 because of the normalization constant Kₜₓ applied at the transmit filter which ensures it has unit total energy. Therefore, to calculate the ACLR, it is only required to compute the in-band energy. The in-band energy can be expressed as:

$${E}_{I} ( Φ ) = {\int }_{- \frac{W}{2}}^{\frac{W}{2}} {\vert {\hat{g}}_{tx} ( f ) \vert}^{2} df$$

where W is the bandwidth of the radio system.

The practical calculation of E_{I}(Φ) depends on the transmit filter implementation.

When the transmit filter is implemented by a neural network (first embodiment), the in-band energy can be approximated by

$${E}_{I} ( Φ ) \approx \frac{1}{\overline{{D}_{tx}}} {\sum }_{i = 1}^{{B}_{5}} {\vert {\hat{g}}_{tx} ( {f}^{[ i ]} ) \vert}^{2}$$

where B₅ is the number of samples used to approximate the in-band energy, and [ĝₜₓ(f₀), . . . , ĝₜₓ(f_{B}_{₅}₋₁)]^{T} is the Discrete Fourier Transform (DFT) of [gₜₓ(t₀), . . . , gₜₓ(t_{B}_{₅}⁻¹)]^{T}, where

$${t}_{i} = - \frac{\overline{{D}_{tx}}}{2} + i \frac{\overline{{D}_{tx}}}{{B}_{4} - 1} ,$$

and D̅ₜ̅ₓ̅>Dₜₓ controls the frequency resolution. To ensure that there is no aliasing on the in-band, B₅ and D̅ₜ̅ₓ̅ shall be chosen such that:

$$\frac{{B}_{5} - 1}{\overline{{D}_{tx}}} > W$$

When the transmit filter is implemented based on sinc function in the frequency domain (second embodiment), the in-band energy can be exactly computed as:

$${E}_{I} ( Φ ) = {K}_{tx} {θ}^{H} C θ .$$

where C is the (2Sₜₓ+1)×(2Sₜₓ+1) matrix which coefficients are given by

$${C}_{{s}_{1} , {s}_{2}} = {\int }_{- \frac{W}{2}}^{\frac{W}{2}} sin c ( {D}_{tx} f - {s}_{1} ) sin c ( {D}_{tx} f - {s}_{2} ) df$$

and can be pre-computed offline, prior to the training.

For example, solving the constrained optimization problem (E) is achieved by using the augmented Lagrangian method to relax (E) to an unconstrained optimization problem that can be solved using a well-known gradient descent algorithm. Thereby, the gradient descent is performed on the augmented Lagrangian:

$${ℒ}_{A} ( Φ , λ , μ ) = 𝒥 ( Φ ) - λ ( ACLR ( Φ ) - ϵ ) + \frac{μ}{2} {( ACLR ( Φ ) - ϵ )}^{2}$$

where μ is the penalty parameter and λ is the Lagrange multiplier.

As depicted in FIG. 5 the learning method comprises an outer loop P1 and an inner loop P2 included in the outer loop P1. The integer m represents the iteration of the learning method.

At step S0, the trainable parameters, the Lagrange multiplier and the penalty parameter are initialized (m=0). The initial values are denoted Φ⁰, λ⁰, and μ⁰ respectively. For example, the initial values Φ⁰ for the trainable parameters are set randomly. The initially value μ⁰ of the penalty parameter is chosen such that p⁰>0.

The inner loop P2 comprises 3 steps S1, S2 and S3. For an iteration m, at step S1, a batch of B₄ bit vectors b^{[b]}∈{0,1}^{NK}, 1≤b≤B₄ is sampled randomly. At step S2 an inference is run through the end-to-end system to compute the channel outputs r^{[b]} and the posterior probabilities on bits

$$\hat{P} ( {b}_{n , k}^{[ b ]} \vert {r}^{[ b ]} ) ,$$

1≤b≤B₄, 1≤n≤N, 1≤k≤K. At step S3, one step of stochastic gradient descent (SGD) is performed to update the set of trainable parameters on the augmented Lagrangian [symbol] _{A}(Φ^{m}, λ^{m}, μ^{m}). The set of trainable parameters obtained as a result of step S3 is saved as Φ^{m+1}. Steps S1 to S3 of inner loop P2 are repeated with the new values Φ^{m+1} of the trainable parameters until a first predefined stop criterium is met.

When the first stop criterium is met, the method continues with Step S4 and step S5. At step S4, the Lagrange multiplier is updated such that: λ^{m+1}=λ^{m}−μ^{m} (ACLR(Φ^{m})−ϵ). At step S5 the penalty parameter is updated such that: μ^{m+1}≥μ^{m}. Then the method loops to step S1 again with the new value of the Lagrange multiplier λ^{m+1} and of the penalty parameter μ^{m+1} until a second predefined stop criterium is met.

The stop criterion can take multiple forms, for example, stop after a predefined number of iterations or when the loss function has not decreased for a predefined number of iterations.

It will be understood that optimizing on the binary cross-entropy [symbol] is equivalent to maximizing the rate:

$$R := {\sum }_{n = 1}^{N} {\sum }_{k = 1}^{K} I ( {b}_{n , k} , r ) - {\sum }_{n = 1}^{N} {\sum }_{k = 1}^{K} {𝔼}_{r} [ {D}_{KL} [ P ( {b}_{n , k} \vert r \vert \vert \hat{P} ( {b}_{n , k} \vert r ) ] ]$$

where I(b_{n,k}; r) is the mutual information between the k^{th} transmitted bit of the n^{th} symbol and the received signal r, D_{KL} is the Kullback-Leibler (KL) divergence, and P(b_{n,k}|r) the true posterior distribution on the bit b_{n,k} conditioned on the received signal r. R can be shown to be an achievable rate for practical bit-interleaved coded modulation (BICM) systems. The first term is an achievable rate assuming that an optimal receiver is used, i.e., one that computes the actual posterior distribution on the bits conditioned on the received signal. The second term is the rate loss due the use of a suboptimal receiver, which is typically the case as implementing the optimal receiver is most often infeasible due to the high complexity it would require or because of the lack of knowledge of the exact channel statistics. Therefore, optimizing the trainable transmitter on the binary cross-entropy [symbol] is equivalent to maximizing an information rate achievable by practical BICM systems.

The parameters can be learned off-line prior to deployment and/or on-line after deployment. For on-line learning, the learning method may be implemented in the transmitter 10 and in the receiver 11. In this embodiment the transmitter 10 and the receiver 11 comprise means for performing one or more or all steps of the learning method. The means may include circuitry configured to perform one or more or all steps of the learning method. The circuitry may be dedicated circuitry. The means may also include at least one processor and at least one memory including computer program code, wherein the at least one memory and the computer program code are configured to, with the at least one processor, cause the transmitter and respectively the receiver to perform one or more or all steps of the learning method.

Alternatively the learning method can be implemented in another apparatus in the network and the learned parameters may be transmitted to the transmitter and the receiver over a network connection.

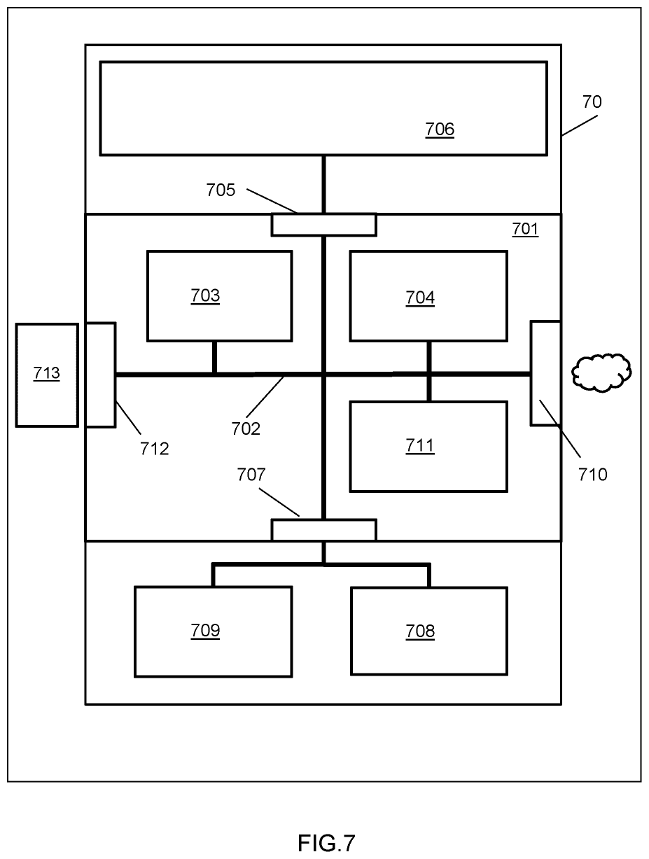

An example of neural network-based detector 17NN will now be described with reference to FIG. 6. The neural network of FIG. 6 comprises an input layer L1 of dimension (N,2) where N is the block size and the second dimension corresponds to the real an imaginary part of the received complex symbol r and an output layer L2 of dimension (N, K), where each value can equivalently be interpreted as a posterior distribution \hat{P}(b_{n,k}|r) on the k^{th} bit b_{n,k} of the n^{th} symbol sₙ given the received vector of symbols r (where K is the number of bits per symbol). In the example of FIG. 6 the neural network comprises a plurality of residual convolutional neural network blocks Q1, . . . , QZ between the input layer L1 and the output layer L2. In a specific embodiment depicted with a dotted line in FIG. 6, the input layer L1 receives transmission related information f for example information about the channel state or information about the modulation order.

FIG. 7 depicts a high-level block diagram of an apparatus 70 suitable for implementing various aspects of a transmitter, a receiver or a learning method as disclosed herein. Although illustrated in a single block, in other embodiments the apparatus 70 may also be implemented using parallel and distributed architectures. Thus, for example, various steps such as those illustrated in the methods described above by reference to FIG. 3 to 6 may be executed using apparatus 70 sequentially, in parallel, or in a different order based on particular implementations.

According to an exemplary embodiment, depicted in FIG. 7, apparatus 70 comprises a printed circuit board 701 on which a communication bus 702 connects a processor 703 (e.g., a central processing unit “CPU”), a random access memory 704, a storage medium 711, possibly an interface 705 for connecting a display 706, a series of connectors 707 for connecting user interface devices or modules such as a mouse or trackpad 708 and a keyboard 709, a wireless network interface 710 and/or a wired network interface 712. Depending on the functionality required, the apparatus may implement only part of the above. Certain modules of FIG. 7 may be internal or connected externally, in which case they do not necessarily form integral part of the apparatus itself. E.g. display 706 may be a display that is connected to the apparatus only under specific circumstances, or the apparatus may be controlled through another device with a display, i.e. no specific display 706 and interface 705 are required for such an apparatus. In an exemplary embodiment, a detachable storage medium 713 such as a USB stick may also be connected. For example the detachable storage medium 713 can hold the software code or data to be uploaded to memory 711.

Memory 711 contains software code which, when executed by processor 703, causes the apparatus to perform the methods described herein, for example the transmission method, the reception method or the learning method. For example, when the apparatus 70 is used to implement a transmitter or a receiver as described above, memory 711 can store inferences of the above-described filtering functions with values for the parameters of the filtering functions of the transmit and receive filters as obtained from the learning method.

The processor 703 may be any type of processor such as a general purpose central processing unit (“CPU”) or a dedicated microprocessor such as an embedded microcontroller or a digital signal processor (“DSP”). Under strict latency constraints, a dedicated signal processor is usually preferred to achieve better performances.

In addition, apparatus 70 may also include other components typically found in computing systems, such as an operating system, queue managers, device drivers, or one or more network protocols that are stored in memory 711 and executed by the processor 703.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure as determined based upon the claims and any equivalents thereof.

For example, the data disclosed herein may be stored in various types of data structures which may be accessed and manipulated by a programmable processor (e.g., CPU or FPGA) that is implemented using software, hardware, or combination thereof.

It should be appreciated by those skilled in the art that any block diagrams herein represent conceptual views of illustrative circuitry embodying the principles of the disclosure. Similarly, it will be appreciated that any flow charts, flow diagrams, state transition diagrams, and the like represent various processes which may be substantially implemented by circuitry.

Each described function, engine, block, step can be implemented in hardware, software, firmware, middleware, microcode, or any suitable combination thereof. If implemented in software, the functions, engines, blocks of the block diagrams and/or flowchart illustrations can be implemented by computer program instructions/software code, which may be stored or transmitted over a computer-readable medium, or loaded onto a general purpose computer, special purpose computer or other programmable processing apparatus and/or system to produce a machine, such that the computer program instructions or software code which execute on the computer or other programmable processing apparatus, create the means for implementing the functions described herein.

In the present description, block denoted as “means configured to perform . . . ” (a certain function) shall be understood as functional blocks comprising circuitry that is adapted for performing or configured to perform a certain function. A means being configured to perform a certain function does, hence, not imply that such means necessarily is performing said function (at a given time instant). Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included. Their function may be carried out through the operation of program logic, through dedicated logic, through the interaction of program control and dedicated logic, or even manually, the particular technique being selectable by the implementer as more specifically understood from the context.

As used herein, the term “and/or,” includes any and all combinations of one or more of the associated listed items.

When an element is referred to as being “connected,” or “coupled,” to another element, it can be directly connected or coupled to the other element or intervening elements may be present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

The disclosure is not limited to sub-terahertz communications and applies generally to any type of communication system.

1. A transmitter for use in a communication system comprising a transmission channel with a channel model, the transmitter comprising:
at least one processor; and
at least one non-transitory memory storing instructions that, when executed with the at least one processor, cause the transmitter to:
perform pulse shaping with a transmit filter to produce a transmit signal subject to at least one signal constraint for transmission over the transmission channel to a receiver comprising a receive filter, the transmit filter being implemented through a filtering function with trainable parameters, wherein the trainable parameters of the filtering function are obtained with joint optimization of the transmit filter and the receive filter to maximize the transmission rate for the channel model and the signal constraint.

2. A receiver for use in a communication system comprising a transmission channel with a channel model and a transmitter, the transmitter comprising a transmit filter to perform pulse shaping to produce a transmit signal subject to at least one signal constraint, the receiver comprising:
at least one processor; and
at least one non-transitory memory storing instructions that, when executed with the at least one processor, cause the receiver to perform:
implementing a receive filter for processing a signal received through the transmission channel from the transmitter, the receive filter being implemented through a filtering function with trainable parameters, wherein the trainable parameters of the filtering function are obtained with joint optimization of the transmit filter and the receive filter to maximize the transmission rate for the channel model and the signal constraint.

3. A transmitter as claimed in claim 1, wherein the instructions, when executed with the at least one processor, implement the filtering function with taking a period of a Fourier series with Fourier coefficients, where the trainable parameters of the filtering function are the Fourier coefficients.

4. A transmitter as claimed in claim 1, wherein the instructions, when executed with the at least one processor, obtain the trainable parameters of the filtering function with joint optimization of the transmit filter, the receive filter, and a neural network implementing at least a detection function of the receiver.

5. A transmitter as claimed in claim 1, wherein the instructions, when executed with the at least one processor, implement the filtering function as an output layer of a neural network having at least one other layer to process transmission related information.

6. A learning method for learning parameters for a transmit filtering function with trainable parameters and a receive filtering function with trainable parameters to be used respectively in a transmitter and a receiver of a communication system comprising a transmission channel, the method comprising:
simulating a channel response taking into account the transmit and receive filters,
simulating a channel noise correlation taking into account the receive filter,
computing channel outputs for random samples with applying the simulated channel response and a random noise correlated to reflect the simulated channel noise correlation, and
learning the trainable parameters with minimizing a loss function subject to at least one signal constraint.

7. A learning method as claimed in claim 6 wherein the signal constraint includes keeping an adjacent channel leakage ratio lower or equal to a predefined value.

8. A learning method as claimed in claim 6 wherein the loss function is minimized with performing a gradient descent on an augmented Lagrangian combining the loss function with the signal constraint.

9. A learning method as claimed in claim 6 wherein the loss function is an estimation of a total binary cross-entropy obtained through Monte Carlo sampling.

10. The use of parameters obtained from a learning method as claimed in claim 6 for filtering a signal with a transmit filter in a transmitter of a communication system.

11. The use of parameters obtained from a learning method as claimed in claim 6 for filtering a signal with a receive filter in a receiver of a communication system.

12. A method for use in a transmitter in a communication system comprising a transmission channel with a channel model, the method comprising:
performing pulse shaping with a transmit filter to produce a transmit signal subject to at least one signal constraint for transmission over the transmission channel to a receiver comprising a receive filter, wherein the transmit filter is implemented with a filtering function with trainable parameters, and the trainable parameters of the filtering function are obtained with joint optimization of the transmit filter and the receive filter to maximize the transmission rate for the channel model and the signal constraint.

13. A method for use in a receiver in a communication system comprising a transmission channel with a channel model and a transmitter, the transmitter comprising a transmit filter to perform pulse shaping to produce a transmit signal subject to at least one signal constraint, the method comprising;
processing, with a receive filter, a signal received through the transmission channel from the transmitter, wherein the receive filter is implemented through a filtering function with trainable parameters, and the trainable parameters of the receive filtering function are obtained with joint optimization of the transmit filter and the receive filter to maximize the transmission rate for the channel model and the signal constraint.

14. A method as claimed in claim 12 wherein the filtering function is implemented with taking a period of a Fourier series with Fourier coefficients, where the trainable parameters of the filtering function are the Fourier coefficients.

15. A non-transitory program storage device readable with an apparatus, tangibly embodying a program of instructions executable with the apparatus for performing the learning method of claim 6.
